(19) United States
(12) Patent Application Publication
(10) Pub. No.: US 2004/0204094 A1
(43) Pub. Date: Oct. 14, 2004

(54) Communicating facility for end users with access device

(76) Inventor: John Huang, Hsin Chuang City (TW)

Correspondence Address: John Huang, P.O. Box 4-67, Hsin Chuang, Taipei, 242, TW

(21) Appl. No.: 10/289,029

(22) Filed: Nov. 4, 2002

(51) Int. Cl. H04M 1/00; H04B 1/38

(52) U.S. Cl. 455/560; 455/550.1

(57) ABSTRACT

A telecommunication communicating facility have two or more wireless network access devices to be communicated with network systems with a single LAN. One of the wireless network access devices includes a processor unit having a detecting device to detect and to receive signals from the other wireless network access devices and end users, and to adjust the frequency or the identification of the wireless network access devices, for allowing the access devices to be communicatable with each other and to be communicatable with the end users.

### BACKGROUND OF THE INVENTION

1. Field of the Invention

The present invention relates to a communicating facility, and more particularly to a telecommunication or wireless communicating facility for facilitating the communication between the end users and the wireless network access devices.

2. Description of the Prior Art

Typical telecommunication or wireless communicating facilities have been developed for communication between the end users and the wireless network access devices, and comprise a number of access devices and a number of local area network (LAN) devices for allowing the end users to communicate with the ethernet or the other network systems.

However, it takes much time to install the access devices and the LAN devices, and a lot of wires or cables and facilities are required to be installed by a lot of workers. In addition, a number of additional access devices are required to be provided and installed in different locations for increasing the communicating flow, and for preventing the transmitting or communicating paths or lines from being crowded or occupied. Furthermore, it will be difficult to inspect and to maintain the telecommunication or wireless communicating facilities.

The present invention has arisen to mitigate and/or obviate the afore-described disadvantages of the conventional telecommunication or wireless communicating facilities.

### SUMMARY OF THE INVENTION

The primary objective of the present invention is to provide a telecommunication communicating facility for facilitating the communication between the end users and the wireless network access devices, and for allowing the end users to be communicated with various network systems via a single local area network and two or more wireless network access devices.

In accordance with one aspect of the invention, there is provided a telecommunication communicating facility comprising a first wireless network access device, a second wireless network access device, a local area network communicating with the second wireless network access device. The first wireless network access device includes a processor unit having a detecting device to detect the second wireless network access device, and to receive signals from the second wireless network access device and end users, and to adjust the first wireless network access device to be communicatable with the second wireless network access device, and an operating device to communicate the end users with the second wireless network access device.

The detecting device detects whether the second wireless network access device is existed within a predetermined range or not, and/or determines whether an internal protocol of the second wireless network access devices is acceptable or not, and/or determines whether an identification of the second wireless network access devices is acceptable or not.

The detecting device may also be used for determining whether a frequency of the second wireless network access devices is acceptable or not, and may adjust the first wireless network access device to be communicatable with the frequency of the second wireless network access device.

The operating device judges whether the signals are the acceptable or not, and/or judges whether an SSID of the signals are the acceptable or not, and/or sends the acceptable signals to the end users, and/or sends the acceptable signals to the second wireless network access device.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is a plan schematic view illustrating the operation of a telecommunication communicating facility in accordance with the present invention;

FIG. 2 is a plan schematic view of the telecommunication communicating facility;

FIG. 3 is a flow chart illustrating the detecting processes conducted by a detecting device of the telecommunication communicating facility; and

FIG. 4 is a flow chart illustrating the sending or receiving or communicating or transmitting processes conducted by an operating device of the telecommunication communicating facility.

### DETAILED DESCRIPTION OF THE PREFERRED EMBODIMENT

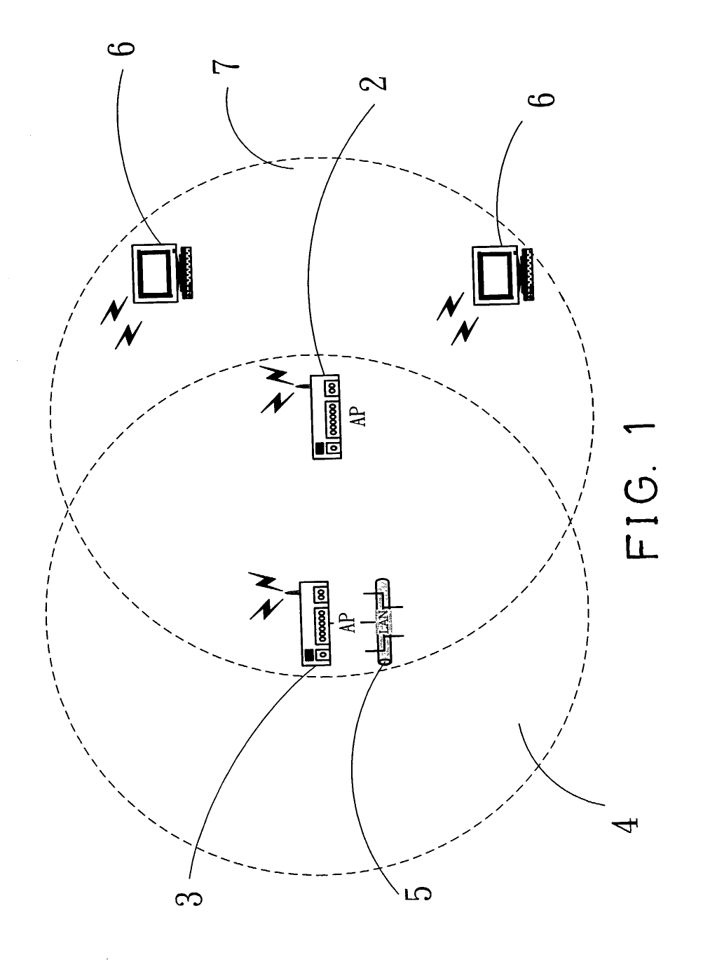

Referring to the drawings, and initially to FIG. 1, a telecommunication communicating facility in accordance with the present invention comprises one or more wireless network access devices 2, 3 disposed or installed within one or more wireless signal areas or ranges 4, 7, at various access points (AP).

For example, the areas or ranges of the wireless signal areas or ranges 4, 7 may be intersected or partially overlapped with each other, and the wireless network access devices 2, 3 may be communicated with each other with such as wireless telecommunication processes, for increasing the area or range of either of the wireless signal area or ranges 4, 7.

The end users located within the overlapping area or range of the wireless signal areas or ranges 4, 7 may communicate with the ethernet or the other network systems via the local area network (LAN) 5 and either or both of the wireless network access devices 2, 3.

It is to be noted that, as shown in FIG. 1, only the wireless network access device 3 has been coupled to or communicated with the local area network (LAN) 5. The other wireless network access device 2 has not been connected or coupled to the local area network (LAN) 5. However, the end users 6 may also be communicated with various network systems via the wireless network access device 2 that has not been connected or coupled to the local area network (LAN) 5.

In addition, the end users 6 located outside the overlapping area or range of the wireless signal areas or ranges 4, 7, but within either of the area or range of the wireless signal areas or ranges 4, 7 may also communicate with the ethernet or the other network systems via the local area network (LAN) 5 and either or both of the wireless network access devices 2, 3, due to the communication between the wireless network access devices 2, 3.

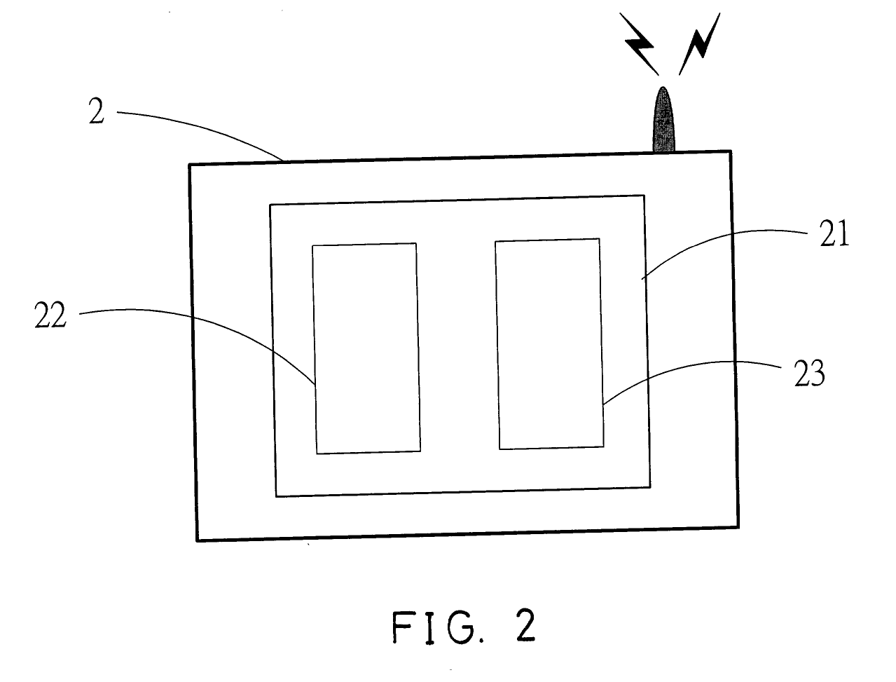

Referring next to FIG. 2, the wireless network access device 2 includes a processor unit 21 having a detecting device 22 for detecting the data or signals or information from the end users, and an operating device 23 for conducting such as the sending or the receiving or the communicating or the transmitting processes.

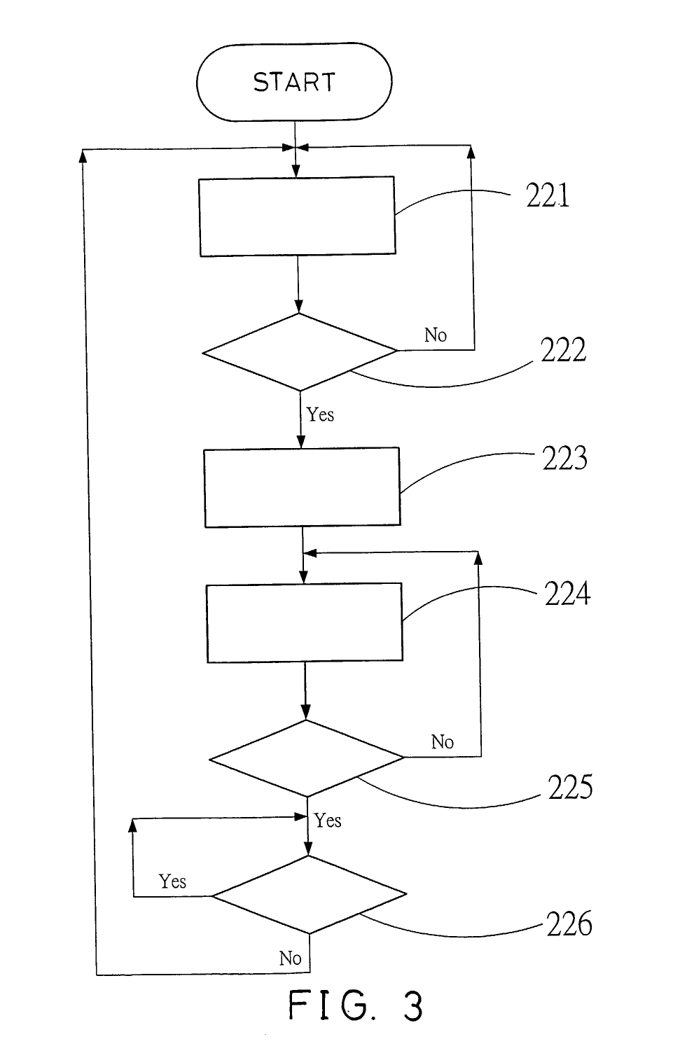

When the detecting device 22 of the wireless network access device 2 is actuated or energized, as shown in FIG. 3, the detecting device 22 will conduct or operate a detecting process 221 to detect whether another wireless network access device 3 is existed within either of the areas or ranges of the wireless signal areas or ranges 4, 7.

When one or more wireless network access devices 3 have been detected to be existed within either of the areas or ranges of the wireless signal areas or ranges 4, 7, the detecting device 22 may operate the searching or identifying process 222, in order to determine whether the internal protocol or the identification or the frequency of the wireless network access devices 3 is the same or not, or is acceptable or qualified or not.

If the internal protocol or the identification or the frequency of the wireless network access devices 3 has been detected or determined or identified to be not the same, or unacceptable or unqualified, the detecting device 22 will conduct or operate the detecting process 221 again and again, to detect whether another wireless network access device 3 is existed within either of the areas or ranges of the wireless signal areas or ranges 4, 7.

On the contrary, when the internal protocol or the identification or the frequency of the wireless network access devices 3 has been detected or determined or identified to be the same, or acceptable or qualified, the detecting device 22 will conduct or operate a setting process 223, to adjust or to set the frequency and/or the working flow rate and/or the service set identifier (SSID) of the wireless network access device 2 that is identical or similar or compatible to that of the wireless network access device 3, for allowing the wireless network access devices 2, 3 to be communicated with each other or to be worked together.

After the frequency and/or the working flow rate and/or the service set identifier (SSID) of the wireless network access device 2 has been adjusted or set or determined to be identical or similar or compatible to that of the wireless network access device 3, the detecting device 22 may restart or reenergize or reactuate the wireless network access device 2 in a reactuating process 224, in order to receive the signals from the end users and/or from the wireless network access device 3.

For example, at this moment, the wireless network access device 2 may treat or process the signals, such as the control or manage signals from the other wireless network access device 3, and may send the signals back to the wireless network access device 3. The wireless network access device 2 may also receive the signals from the end users 6, for facilitating the end users 6 to transmit or communicate with various network systems.

Following the reactuating process 224, the detecting device 22 may justify whether the wireless network access device 2 has been restarted or reenergized or reactuated or not in a justifying process 225. For example, a value “1” will be sent to the justifying process 225 when the wireless network access device 2 has been restarted or reenergized or reactuated, and another value “0” will be sent to the process 225 when the wireless network access device 2 has not been restarted or reenergized or reactuated.

In the justifying process 225, when the value “0” is received or when the wireless network access device 2 has not been reactuated, the detecting device 22 may repeat the process 224 again, in order to receive the signals from the end users and/or from the wireless network access device 3 again.

On the contrary, when the value “1” is received or when the wireless network access device 2 has been reactuated, the detecting device 22 may move to the confirming process 226 in order to detect or to check or to determine or to confirm whether the wireless network access device 3 has continuously sending signals out to the wireless network access device 2 or not.

The detecting device 22 may repeat the confirming process 226 when the wireless network access device 3 has been confirmed to be continuously sent signals out to the wireless network access device 2; and may move to operate the detecting process 221 again, in order to again detect whether another wireless network access device 3 is existed within either of the areas or ranges of the wireless signal areas or ranges 4, 7.

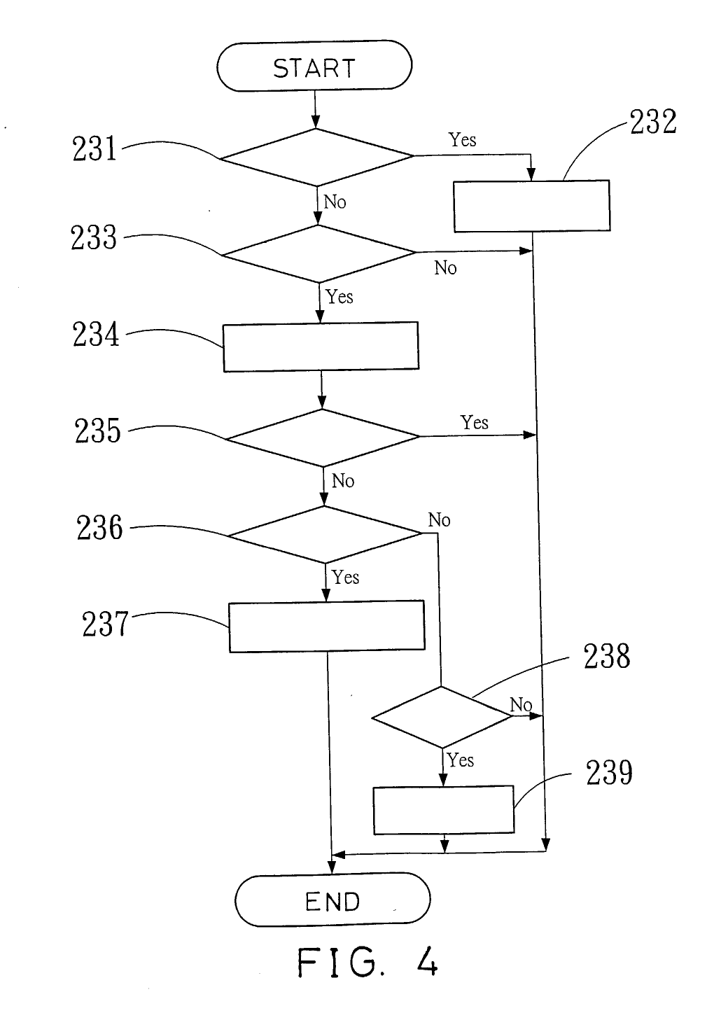

Referring next to FIG. 4, when the wireless, network access device 2, or when the detecting device 22 of the wireless network access device 2 receives signals from the end users and/or from the wireless network access device 3, the operating device 23 may conduct or operate a first judging process 231 to evaluate or to determine or to judge whether the signals are the acceptable or qualified control or manage signals or packages.

If the signals are the acceptable or qualified control or manage signals or packages, the control or manage signals may then be communicated or transmitted through a transmitting process 232. If the signals are not acceptable or qualified, the operating device 23 may conduct or operate a second judging process 233 to evaluate or to determine or to judge whether the signals are data signals or not.

If the signals are not the data signals, the signals will be rejected or removed. On the contrary, if the signals are the acceptable or qualified data signals, the signals will be justified in another or in a third justifying process 234, in order to justify whether the SSID of the signals is acceptable or qualified or not.

The signals will be rejected or removed if the SSID of the signals is not acceptable or qualified. On the contrary, if the SSID of the signals is acceptable or qualified, the signals will be subjected with a filtering process 235 in order to examine whether the receiver or the destination of the signals is within the area or range of the wireless network access device 2.

If the receiver or the destination of the signals is within the area or range of the wireless network access device 2, the signals are not required to be treated or processes, and will be directed rejected or removed. On the contrary, if the receiver or the destination of the signals is not within the area or range of the wireless network access device 2, the operating device 23 will conduct or operate a testifying process 236, in order to testify whether coming from the wireless network access device 3 or not, or whether the signals are the broadcasting or advertising signals or not.

In the testifying process 236, if the signals or the packages are testified to be from the wireless network access device 3 and/or are the broadcasting or advertising signals, the signals will be transmitted to the end users 6 in the transmitting process 237.

On the contrary, if the signals or the packages are testified not to be from the wireless network access device 3 and/or are not the broadcasting or advertising signals, the signals will be testified again by another testifying process 238, in order to determine whether the signals are from the acceptable or qualified or identified end users 6 or not.

If the signals have been determined to be from the acceptable or qualified or identified end users 6, the signals will be transmitted to the wireless network access device 3 in another transmitting process 239. On the contrary, if the signals have been determined to be not from the acceptable or qualified or identified end users 6, the signals will be rejected or removed.

In operation, as shown in FIG. 1, the end users 6 may also be communicated with various network systems via the wireless network access device 2 that has not been connected or coupled to the local area network (LAN) 5. The wireless network access device 2 may be communicated with various network systems via the wireless network access device 3 that has been coupled to the local area network (LAN) 5, such that only one local area network (LAN) 5 is good enough for allowing two or more wireless network access devices 2, 3 to be communicated with various network systems.

Accordingly, the telecommunication communicating facility in accordance with the present invention for facilitating the communication between the end users and the wireless network access devices, and for allowing the end users to be communicated with various network systems via a single local area network and two or more wireless network access devices.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A telecommunication communicating facility comprising:
a) a first wireless network access device,
b) a second wireless network access device,
c) a local area network communicating with said second wireless network access device,
said first wireless network access device including a processor unit having:
i) a detecting device to detect said second wireless network access device, and to receive signals from said second wireless network access device and end users, and to adjust said first wireless network access device to be communicatable with said second wireless network access device, and
ii) an operating device to communicate the end users with said second wireless network access device.

2. The telecommunication communicating facility according to claim 1, wherein said detecting device detects whether said second wireless network access device is existed within a predetermined range or not.

3. The telecommunication communicating facility according to claim 1, wherein said detecting device determines whether an internal protocol of said second wireless network access devices is acceptable or not.

4. The telecommunication communicating facility according to claim 1, wherein said detecting device determines whether an identification of said second wireless network access devices is acceptable or not.

5. The telecommunication communicating facility according to claim 1, wherein said detecting device determines whether a frequency of said second wireless network access devices is acceptable or not.

6. The telecommunication communicating facility according to claim 5, wherein said detecting device adjust said first wireless network access device to be communicatable with said frequency of said second wireless network access device.

7. The telecommunication communicating facility according to claim 1, wherein said operating device judges whether the signals are the acceptable or not.

8. The telecommunication communicating facility according to claim 7, wherein said operating device judges whether an SSID of the signals are the acceptable or not.

9. The telecommunication communicating facility according to claim 7, wherein said operating device sends the acceptable signals to said end users.

10. The telecommunication communicating facility according to claim 7, wherein said operating device sends the acceptable signals to said second wireless network access device.
